(19) United States
(12) Patent Application Publication
(10) Pub. No.: US 2004/0089160 A1
(43) Pub. Date: May 13, 2004

(54) Ever-clean compound utensil

(76) Inventor: George J. Doundoulakis, North Bellmore, NY (US)

Correspondence Address: George J. Doundoulakis, 2498 Kayron Lane, North Bellmore, NY, 11710, US

(21) Appl. No.: 10/288,669

(22) Filed: Nov. 7, 2002

(51) Int. Cl. A47J 37/10

(52) U.S. Cl. 99/422

(57) ABSTRACT

The invention relates to a utensil having a rigid section 2, covered with a foil, such as aluminum foil for cooking, then to be stored away clean without the need of washing by simply pilling off and discarding the foil. The foil is applied over the surface of section 2, acting as a female molding section, as a section 1, acting as a male molding section and having a surface complementary to that of section 2, presses the foil against its surface. Additional means are disclosed for providing ridges and grooves to the shape of the foil so that meat, held on top of the ridges, can be cooked outside its fat, which would drain into the grooves.

### DESCRIPTION

1. Technical Field

The present invention relates to utensils and in particular to a novel and inexpensive method of keeping utensils covered with inexpensive foil while the food is being cooked; then being stored away clean without the need of washing by discarding the greasy foil.

2. Background and Prior Art

There exist today utensils pressed out of aluminum foil in the form of pans to be used for oven broiling and baking then be thrown out to save the housewife the trouble of washing. The drawbacks with their use are:

(1) There are flimsy; therefore difficult to be held without bending, endangering to spill the food contained by them.

(2) When they are being used, they are often not thrown out but are washed and saved away for the next time, defeating the purpose of their use.

(3) While much cheaper than a regular pan they are still costly, a substantial portion of a dollar per pan, depending on size, so the house wife often decides in favor of using the old steady pan and wash afterwards rather than throwing away money for saving work.

### DESCRIPTION OF THE PRESENT INVENTION

The present invention, here being illustrated as would be used in the case of pans, provides for a pair of parts in the form of and size of a desired pan. The parts are designed to loosely fit together, like molds the smaller as a male section inside the slightly larger female section with a piece of aluminum foil, roughly cut out of a roll of aluminum foil, flat or pre-corrugated, in size larger than the forming parts, placed in between them to be formed in the shape of a pan by simply squeezing the assembly together. The surface of the molding sections may be smooth, in accordance with Embodiment A, or it may be carved according to Embodiment B to provide ridges and grooves, which then, are being transferred to the interposed aluminum, for keeping the meat at the top of the ridges, while the fat runs into the grooves. The excess of aluminum left outside the female molding section can be roughly trimmed and bent over its edge all around, to help it stay in place with the female section. The male portion is subsequently removed and set aside, while the female portion, covered with the aluminum foil, is used as the sturdy broiling or baking pan. After the cooked food is removed, the inexpensive aluminum foil, greasy as it may be, is discarded, while the two molding sections can be stored away clean for future use, without the need of washing.

It is the main object of the present invention to provide the housewife with a sturdy, inexpensive cooking utensil, such as a pan, for cooking, without the need of washing afterwards. This is accomplished by keeping a rigid female molding member in the form of a pan covered with a piece of foil while cooking, and left clean after cooking by having the foil, greasy as it may be, removed and discarded.

It is another object of the present invention to save the expense for a non-sticking Teflon or other type of coating on a pan.

Still another object of the present invention is to cover a utensil which, in addition, can provide a ridged surface for the meats to be cooked outside their fat.

Other objects and features of the invention will be discussed as the description of the particular physical embodiments are selected to illustrate the invention processes. The various novel features that characterize the invention are pointed out particularly in the claims annexed to and forming a part of this specification. In addition, for the better understanding of the invention, its operation advantages and specific objects attained by its use, references are made to the accompanying drawings and descriptive matter in which preferred embodiments of the invention are illustrated and described.

The invention is illustrated diagrammatically, in the accompanying drawings by way of examples. The diagrams illustrate only the principles of the invention and how these principles are employed in the various fields of application. It is however to be understood that the purely diagrammatic showing does not offer a survey of other possible constructions and a departure from the constructional features diagrammatically illustrated, does not necessarily imply a departure from the principles of the invention. For example, while the diagrams illustrate how the invention is applied in the case of a pan, the principles of the invention equally apply in the case of cooking pots. Similarly, while the means employed to cover the rigid portion of the utensil is indicated to be aluminum foil covering a rigid pan, which is made out of metal, the invention intends to equally refer to a rigid utensil such as a platter, made out of plastic material and covered by a plastic foil such as a clear plastic wrap for cooking or warming food in a microwave oven.

It is, therefore to be understood that the invention is capable of numerous modifications and variations to those skilled in the art without departing from the spirit of the invention.

In the accompanying drawings, forming part hereof, similar reference characters designate corresponding parts.

### BRIEF DESCRIPTION OF THE DRAWINGS

The details of my invention will be described in connection with the accompanying drawings, in which:

FIG. 1 is a side elevation cross-sectional view showing a first step where two molding sections are to operate on a piece of interposed flat foil, such as aluminum foil, for the purpose of shaping it along their complimentary surfaces and in accordance with embodiment A of the invention.

FIG. 2 is a top view of the parts shown in FIG. 1.

FIG. 3 is a side elevation cross-sectional view of the parts shown in FIGS. 1 and 2, showing the male molding section pushed inside the female molding section, while the interposed flat foil, has been shaped along the complimentary surfaces provided by the molding sections and in accordance with embodiment A of the invention.

FIG. 4 is a side elevation cross-sectional view of the last step in arriving at a desired utensil, where, after removal of the male molding section, the finished utensil, here shown as a pan, is complete, comprising the female molding section providing a rigid base, covered on the top side with said foil, while the excess of foil is roughly trimmed and bent over the edge for better fastening of the foil onto the rigid female molding section; thereby operating as single a unit.

FIG. 5 is an isometric view of a pre-corrugated piece of aluminum foil that can be processed in the same way as the flat piece of aluminum shown in the FIGS. 1 through 4, to cover the female molding section in accordance with Embodiment C.

FIG. 6 is an isometric view of a spacer frame to be positioned between the male molding section and foil for keeping the bottom of the male section from approaching the bottom of the female section a distance less than the overall height of said pre-corrugated foil shown in FIG. 5, where it would crush the corrugations of the aluminum.

FIG. 7 is an isometric top view of a finished utensil in accordance with Embodiment B of the invention, showing the foil covering a rigid female section comprising ridges and grooves with communicating channels carved onto its surface, pressed by the surface of the male section to conform with the complementary surface of the molding sections, while roughly trimmed and bent around the edge all around.

FIG. 8 is an isometric top view of a finished utensil in accordance with Embodiment C of the invention, showing a rigid female section covered with the pre-corrugated aluminum foil of FIG. 5, with the corrugations shown crushed against the sides of the female molding section by the sides of the mail forming section, but remaining in tact along the bottom surface of the utensil with the help of the spacing frame of FIG. 6.

### BEST MODE FOR CARRYING OUT THE INVENTION

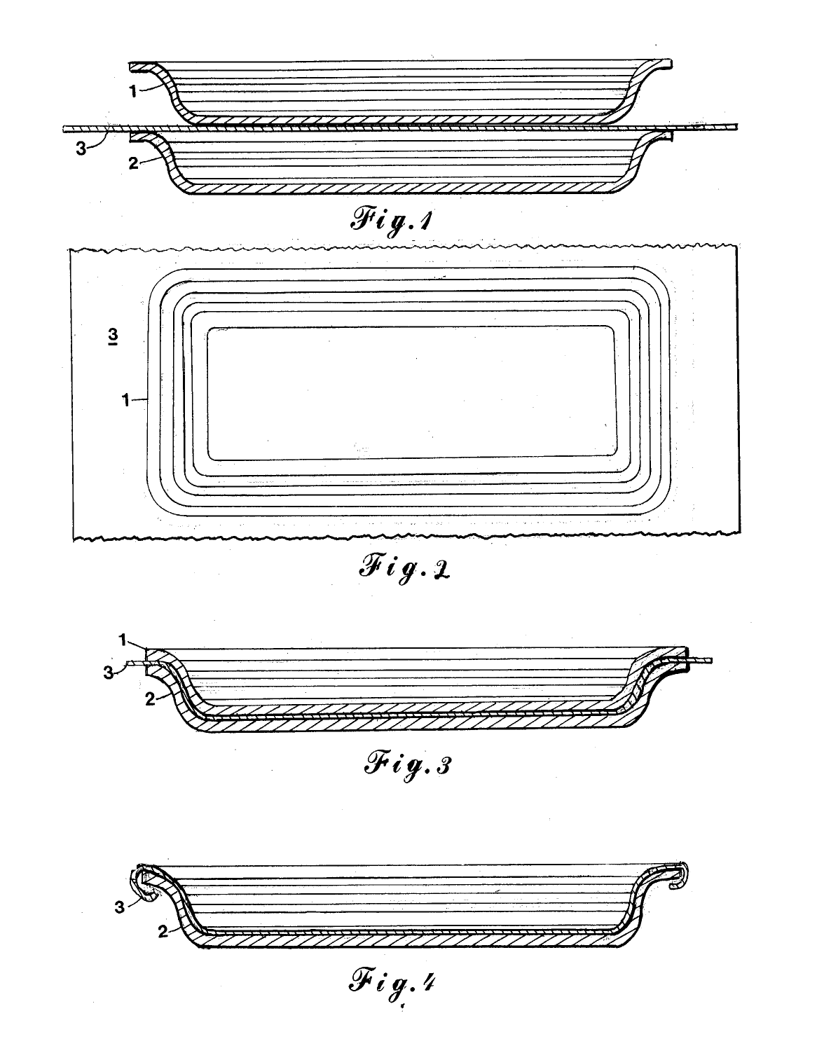

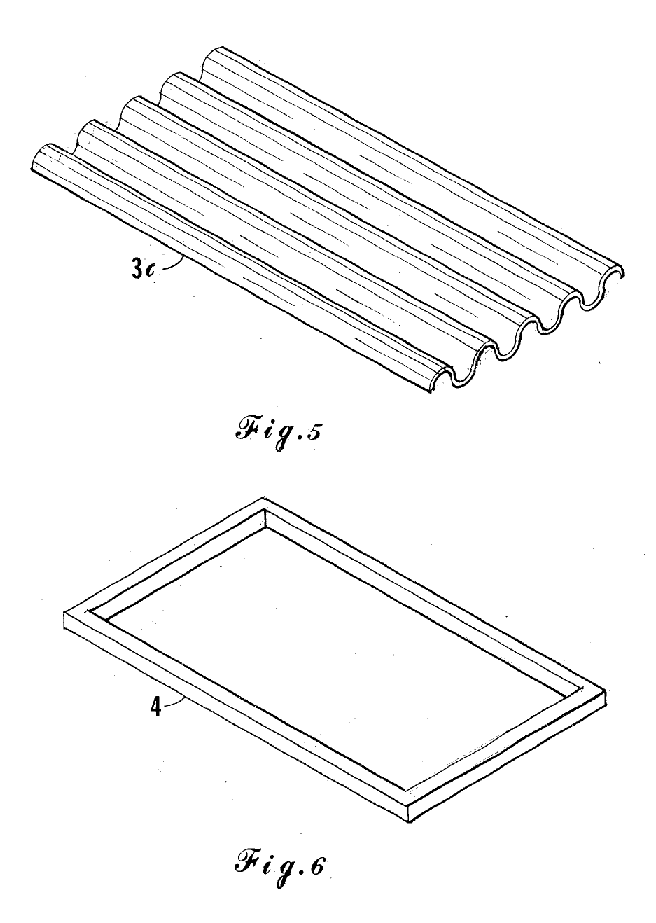

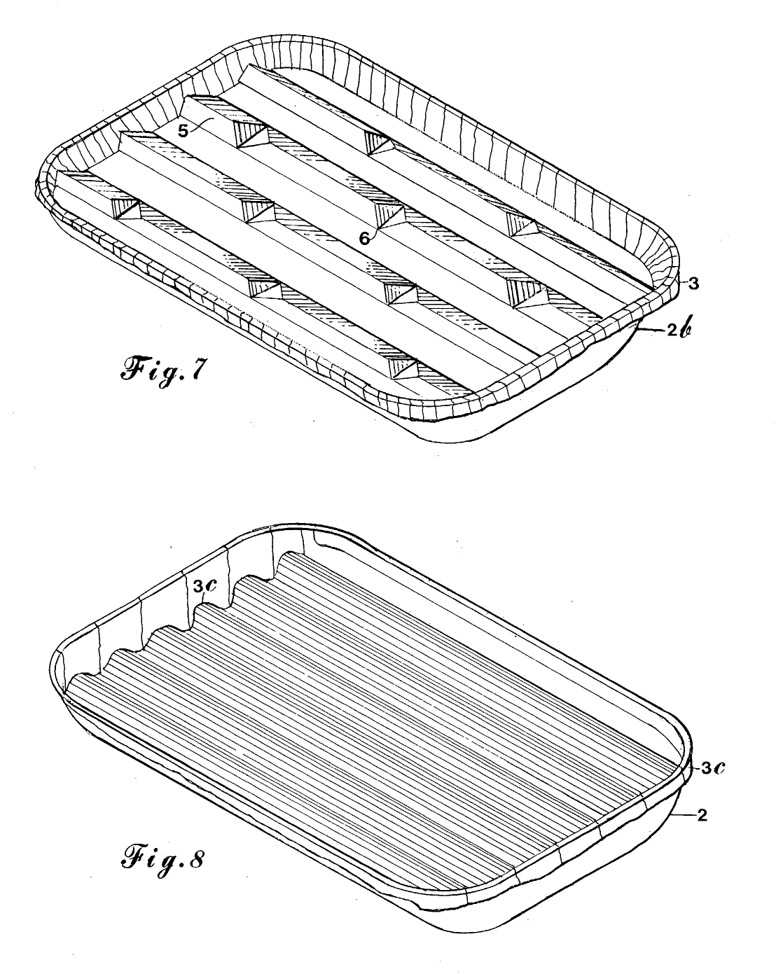

Referring to FIGS. 1 and 2, a rigid section 1 in the form of a male forming section and shape of a desired pan is shown positioned over a corresponding rigid female forming section 2, with a piece of foil such as aluminum foil 3, placed in between to be formed along the complimentary surfaces of said molding sections. The complimentary surfaces of sections 1 and 2 may be smooth according to Embodiment A, or they may be carved into ridges, grooves and channels, according to Embodiment B, as shown in FIG. 7. As already explained the purpose of the ridges is to keep meat outside its fat, which can drain into the grooves. Next, as shown in FIG. 3, the two molding sections 1 and 2 are squeezed together, whereby the foil 3 is shaped along the complimentary surfaces provided by the two sections. Section 1 is then shown removed in FIG. 4, with the foil left covering the sturdy female molding section 2. The foil left outside the molding sections, is shown roughly trimmed all around and bent over the edge for better fastening of the foil onto the rigid section 2. This is the desired sturdy utensil to be used for cooking as previously explained. After use, the rigid section 2 may be retrieved clean by simply pilling off and discarding the foil 3.

Instead of providing oppositely complimentary ridges and grooves along the surfaces of the molding sections 1 and 2, according to Embodiment B shown in FIG. 7, FIG. 5 shows Embodiment C, where a pre-corrugated piece of foil 3a is used instead of the flat foil 3. A spacer frame 4, may be placed between the aluminum 3a and section 1, (or other means can be used, such as flaps, not shown, hinged along two opposite sides of section 1), to prevent the bottom of the male section 1 from advancing to a distance less than the overall height of the corrugations of FIG. 5, from the bottom of section 2; thereby, preventing the corrugations from being crushed.

I claim:

1. A utensil for cooking, warming up or baking of food on top of a gas or electric cookstove or in a regular size oven, a microwave, or a toaster oven, comprising a first rigid section operable as a male molding section, a second rigid section operable as a corresponding female molding section, foil interposed between said molding sections to be shaped along the complimentary surfaces of said sections when they are pressed together with the male section inside the female section; whereas, removal of the male molding section leaves the female section covered by said foil to be used as a sturdy utensil for cooking as stated above and left clean afterwards, as said foil, greasy as it may be, is removed and discarded.

2. A utensil for cooking, warming up or baking of food on top of a gas or electric cookstove or in a regular size oven, a microwave, or a toaster oven, comprising a first rigid section operable as a male molding section, a second rigid section operable as the female molding section, said molding sections comprising complimentary ridges and grooves carved on their surfaces; foil interposed between said molding sections to be shaped along the complimentary surfaces of said molding sections when pressed together, with the male section inside the female section; whereas, subsequent removal of the male molding section, leaves the female section covered with said foil to be used as the desired sturdy utensil for cooking as stated above, with said ridges keeping meat outside its grease, which runs into the grooves; and whereas, after cooking, said second rigid section is left clean after said foil, greasy as it may be, is removed from its surface and discarded.

3. A utensil for cooking, warming up or baking of food on top of a gas or electric cookstove or in a regular size oven, a microwave or a toaster oven, comprising a first rigid section operable as a male molding section, a second rigid section operable as the female molding section, pre-corrugated foil interposed between said molding sections to be shaped along the sides of said forming sections, when they are pressed together, with the male section inside the female section; means for stopping the bottom of the male section from approaching the bottom of the female section a distance less than the overall height of said pre-corrugated foil, for the corrugations to stay in tact; whereas, subsequent removal of the male molding section, leaves the female section covered by said foil to be used as the desired sturdy utensil for cooking as stated above, with said corrugated foil keeping meat outside its grease, and whereas said second rigid section, is left clean after cooking, as said foil, greasy as it may be, is being removed and discarded.
